(19) United States
(12) Patent Application Publication
(10) Pub. No.: US 2026/0015181 A1
(43) Pub. Date: Jan. 15, 2026

(54) EJECTION DEVICE

(71) Applicant: Primax Electronics Ltd., Taipei City (TW)

(72) Inventors: CHIA-HSUAN KUNG, Taipei City (TW); Hsien-Cheng Peng, Taipei City (TW); Chun-Nan Lin, Taipei City (TW)

(21) Appl. No.: 18/797,550

(22) Filed: Aug. 8, 2024

(30) Foreign Application Priority Data
Jul. 15, 2024 (TW) 113126448

(51) Int. Cl. B65G 31/00; A01K 5/02

(52) U.S. Cl. CPC B65G 31/00; A01K 5/02

(57) ABSTRACT

An ejection device includes a housing and an ejection member. The housing defines a feed channel, an ejection channel and a discharge opening. A portion of the ejection channel has a recess facing an end of the feed channel. The ejection member is partially disposed in the ejection channel and includes a push rod and an elastic member. The push rod has a top portion facing the discharge opening. A width of the top portion of the push rod is smaller than a width of the ejection channel. The elastic member is adjacent to the top portion of the push rod and surrounds a portion of the push rod that is disposed in the ejection channel. When the elastic member is not compressed, at least a portion of the top portion of the push rod is between the end of the feed channel and the recess.

### FIELD OF THE INVENTION

The present invention relates to an ejection device, in particular to a food ejection device.

### BACKGROUND OF THE INVENTION

Most food supply devices (e.g., pet feeding machines) on the market use solenoid valves. However, if food is expected to be ejected to a farther distance (e.g., an ejection distance is greater than 20 cm), a larger solenoid valve should be used, but its power consumption is higher. Therefore, a novel food supply device is needed to solve the above issues.

### SUMMARY OF THE INVENTION

The present invention provides an ejection device, which includes a housing and an ejection member. The housing defines a feed channel, an ejection channel and a discharge opening, in which one end of the feed channel is connected to a portion of the ejection channel, and the portion of the ejection channel has a recess facing the end of the feed channel, and one end of the ejection channel away from the feed channel is connected to the discharge opening. The ejection member is partially disposed in the ejection channel. The ejection member includes a push rod and an elastic member. The push rod has a top portion facing the discharge opening, in which a width of the top portion of the push rod is smaller than a width of the ejection channel. The elastic member is adjacent to the top portion of the push rod and surrounds a portion of the push rod that is disposed in the ejection channel, in which when the elastic member is not compressed, at least a portion of the top portion of the push rod is between the end of the feed channel and the recess.

In some embodiments of the present invention, the housing has a partition portion disposed at another end of the ejection channel opposite to the end thereof, and the partition portion has a through hole, and the push rod is through the through hole, and the elastic member abuts the partition portion.

In some embodiments of the present invention, the recess is located within a vertical projection of the feed channel, and the recess is offset toward the discharge opening relative to the vertical projection of the feed channel.

In some embodiments of the present invention, the top portion of the push rod is cone-shaped or truncated-conical.

In some embodiments of the present invention, the push rod includes: a rod body and a top member. The top member covers a top portion of the rod body.

In some embodiments of the present invention, the elastic member is a conical spring.

In some embodiments of the present invention, the ejection device further includes a driving assembly, which includes a gear and a driving member. The gear has a main body and two teeth disposed on an outer circumferential surface of the main body and separated from each other. The driving member is configured to drive the gear to rotate, in which the push rod further has a convex portion adjacent to the gear, and when the driving member drives the gear to rotate, one of the two teeth interferes with the convex portion to drive the push rod to move in a direction away from the discharge opening to compress the elastic member.

In some embodiments of the present invention, when the driving member continues to drive the gear to rotate, the one of the two teeth leaves the convex portion to release the elastic member and drive the push rod to eject.

In some embodiments of the present invention, the main body of the gear has a convex shaft extending outward from a peripheral region of an outer surface of the main body.

In some embodiments of the present invention, the ejection device further includes a stirring member, in which one end of the stirring member is pivotally connected to the convex shaft, and another end of the stirring member is close to or located in the feed channel, in which when the driving member drives the gear to rotate, the convex shaft drives the stirring member to move.

### BRIEF DESCRIPTION OF THE DRAWINGS

Aspects of the present invention are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is an appearance diagram of an ejection device according to an embodiment of the present invention.

FIG. 2 to FIG. 6 are internal structure diagrams of an ejection device according to an embodiment of the present invention during an ejection process.

### DETAILED DESCRIPTION OF THE PREFERRED EMBODIMENT

The advantages and features of the present invention and the method for achieving the same will be described in more detail with reference to exemplary embodiments and accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over.” The spatially relative descriptions used herein should be interpreted the same.

As mentioned in the prior art, most food supply devices (e.g., pet feeding machines) on the market use solenoid valves. However, if food is expected to be ejected to a farther distance (e.g., an ejection distance is greater than 20 cm), a larger solenoid valve should be used, but its power consumption is higher. Therefore, the present invention provides an ejection device, which includes a housing and an ejection member (including a push rod and an elastic member). Food can be ejected to a farther distance (e.g., an ejection distance is greater than 20 cm) by the ejection member, which is more power-saving, so it can effectively solve the issues described in the prior art. On the other hand, an ejection channel of the housing of the present invention has a recess facing the feed channel, and a slope of the recess can guide the food (e.g., feed, snacks) falling outside an ejection range of the ejection member into the recess, so that it is in a position ready to be ejected. As such, the ejection member can successfully eject the food later. In addition, in the present invention, a width of a top portion of the push rod of the ejection member is smaller than a width of the ejection channel, and when the elastic member of the ejection member is not compressed, at least a portion of the top portion of the push rod is between one end (e.g., a lower end) of the feed channel and the recess. Therefore, when the ejection member ejects, it can first hit the food in the position ready to be ejected (i.e., located in the recess) without first hitting the food stuck between the lower end of the feed channel and the ejection channel. Various embodiments of the ejection device of the present invention will be described in detail below.

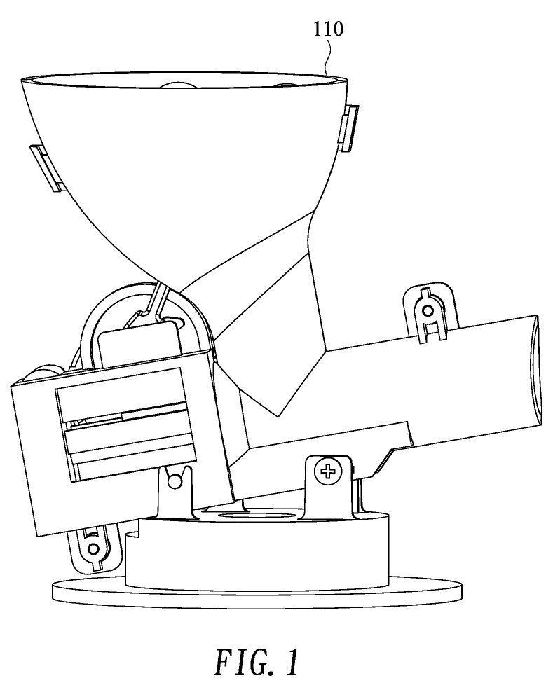

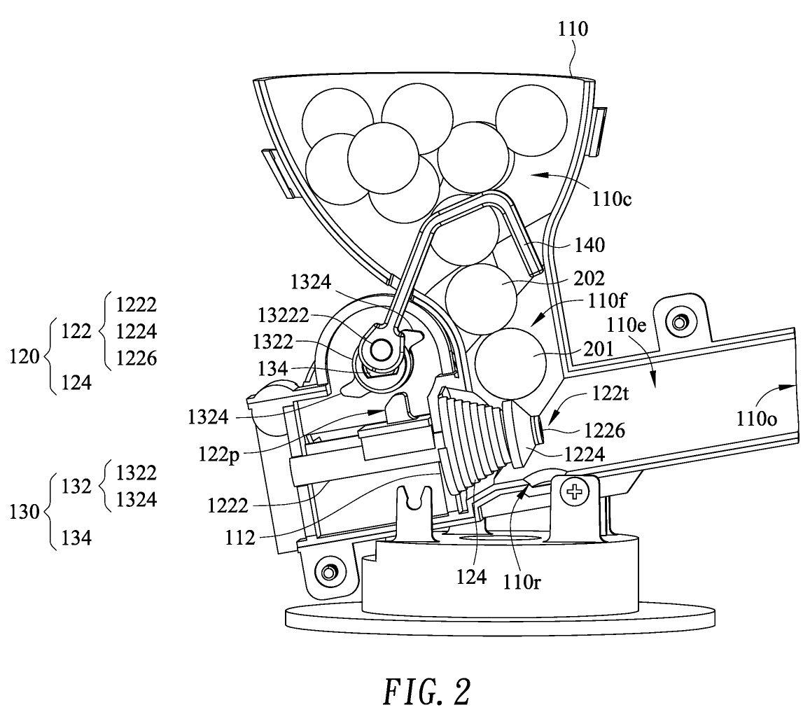

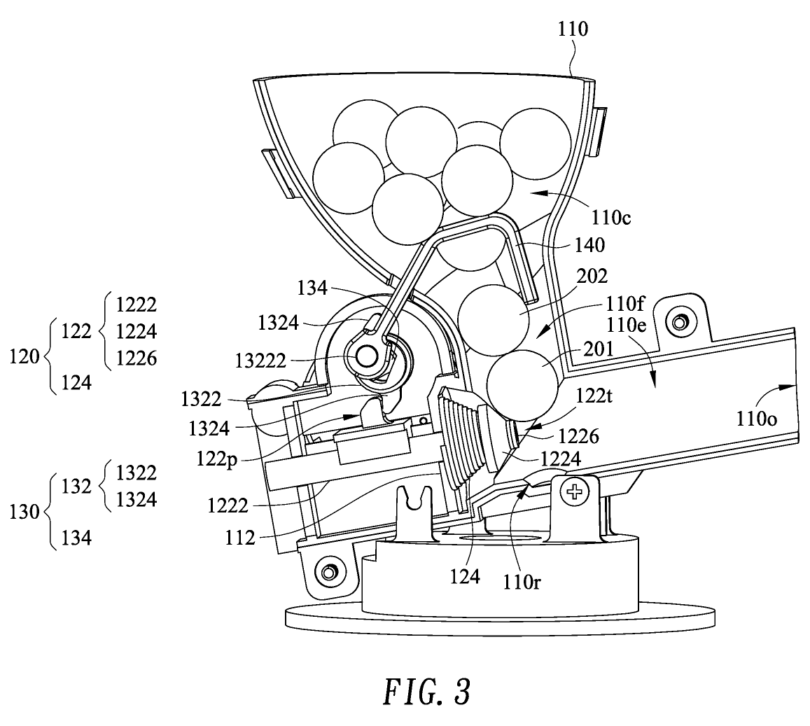

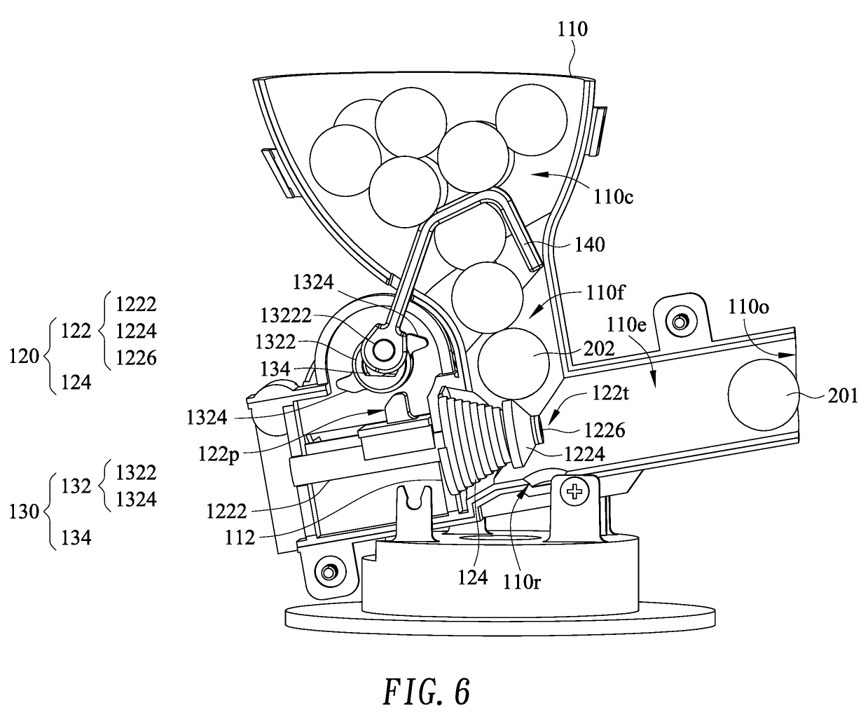

FIG. 1 is an appearance diagram of an ejection device according to an embodiment of the present invention. FIG. 2 to FIG. 6 are internal structure diagrams of an ejection device according to an embodiment of the present invention during an ejection process. As shown in FIGS. 1 and 2, the ejection device includes a housing 110 and an ejection member 120.

The housing 110 defines a feed channel 110f, an ejection channel 110e and a discharge opening 110o. One end (e.g., a lower end) of the feed channel 110f is connected to a portion of the ejection channel 110e. Another end (e.g., an upper end) of the feed channel 110f is connected to a container 110c. The portion of the ejection channel 110e has a recess 110r facing the end of the feed channel 110f. One end of the ejection channel 110e away from the feed channel 110f is connected to the discharge opening 110o. In some embodiments, the ejection channel 110e is tilted, and the end of the ejection channel 110e connected to the discharge opening 110o is higher than an opposite end of the ejection channel 110.

It is worth noting that a slope of the recess 110r can guide the food falling outside an ejection range of the ejection member 120 into the recess 110r, so that it is in a position ready to be ejected. As such, the ejection member 120 can successfully eject the food. In some embodiments, the recess 110r is located within a vertical projection of the feed channel 110f, and the recess 110r is offset toward the discharge opening 110o relative to the vertical projection of the feed channel 110f. As such, it is beneficial to guide the food falling outside the ejection range of the ejection member 120 (i.e., closer to the discharge opening 110o) into the recess 110r.

The ejection member 120 is partially disposed in the ejection channel 110e. In some embodiments, a portion of the ejection member 120 is disposed in the ejection channel 110e, and another portion thereof is disposed in a driving region (not marked). The ejection member 120 includes a push rod 122 and an elastic member 124.

The push rod 122 has a top portion 122t facing the discharge opening 110o. A width of the top portion 122t of the push rod 122 is smaller than a width of the ejection channel 110e. In some embodiments, the top portion 122t of the push rod 122 is cone-shaped or truncated-conical.

The elastic member 124 is adjacent to the top portion 122t of the push rod 122 and surrounds a portion of the push rod 122 that is disposed in the ejection channel 110e. When the elastic member 124 is not compressed, at least a portion of the top portion 122t of the push rod 122 is between the end of the feed channel 110f and the recess 110r. In some embodiments, when the elastic member 124 is not compressed, at least the portion of the top portion 122t of the push rod 122 corresponds to the recess 110r. In some embodiments, when the elastic member 124 is not compressed, a vertical projection of the top portion 122t of the push rod 122 is overlapped with a vertical projection of the recess 110r. In some embodiments, the elastic member 124 is a conical spring. It is worth noting that compared with an ordinary spring, the conical spring is thinner after compression and take up less space.

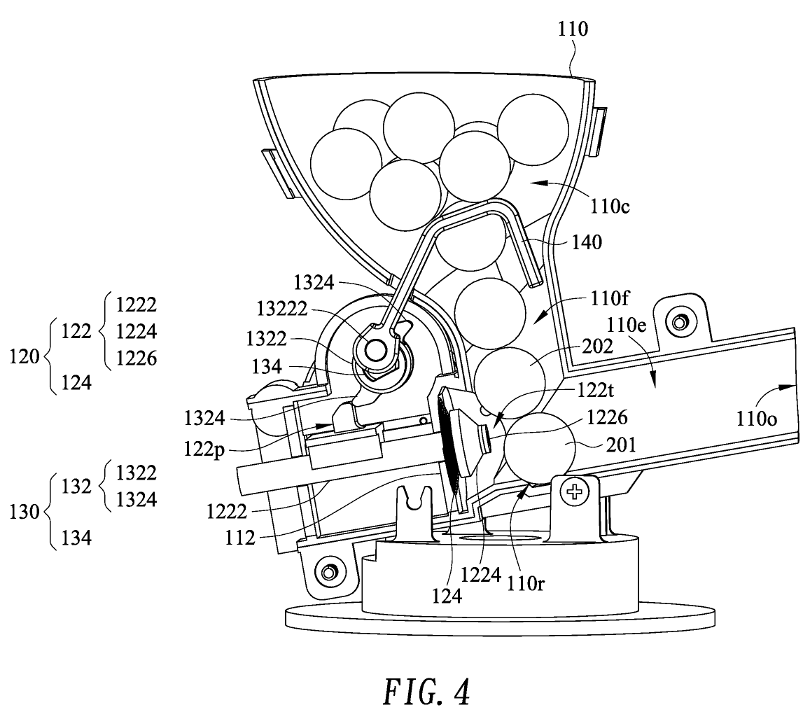

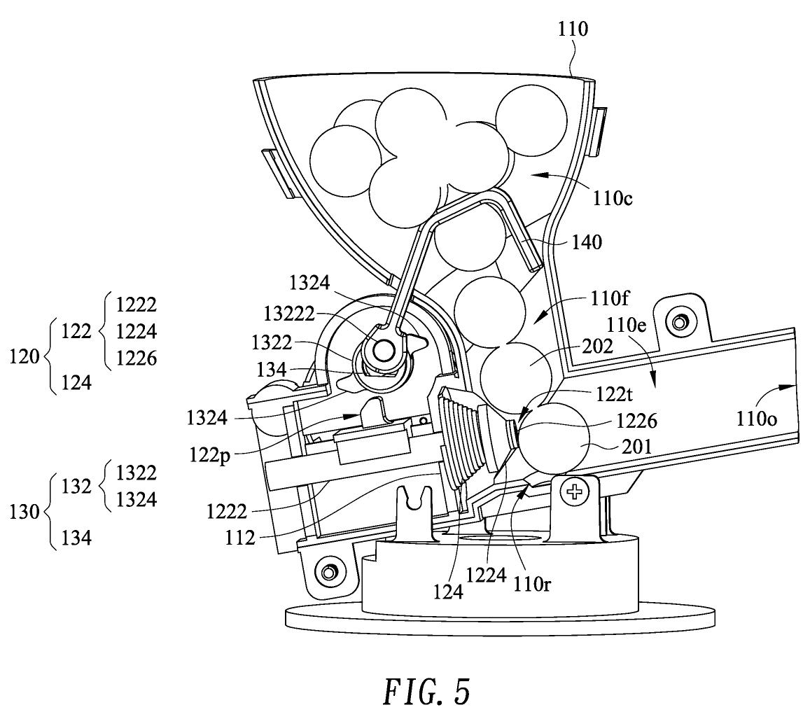

It is worth noting that the arrangement of the recess 110r, and the width of the top portion 122t of the push rod 122 is less than the width of the ejection channel 110e, and at least the portion of the top portion 122t of the push rod 122s is between the end (e.g., the lower end) of the feed channel 110f and the recess 110r when the elastic member 124 is not compressed. Therefore, when the ejection member 120 ejects, it can first hit the food in the position ready to be ejected (e.g., the food 201 shown in FIGS. 4 and 5) without first hitting the food stuck between the lower end of the feed channel 110f and the ejection channel 110e (e.g., the food 202 shown in FIGS. 4 and 5).

However, the present invention is not limited to the above embodiments. In practical applications, the relative position, shape and size of the top portion 122t of the push rod 122 and the recess 110r can be appropriately adjusted according to the shape and size of the food, so that the ejection member 120 can accurately hit the food in the position ready to be ejected.

As a counterexample, if there is an ejection member (not shown) whose top width is substantially the same as the width of the ejection channel, when this ejection member ejects, it first hits the food stuck between the lower end of the feed channel and the ejection channel (e.g., the food 202 shown in FIG. 4), but cannot effectively eject it (due to the obstruction of the housing at the lower end of the feed channel), nor can it eject the food located in the ejection channel (e.g., the food 202 shown in FIG. 4). Therefore, this ejection member has poor ejection efficiency.

In some embodiments, the housing 110 has a partition portion 112, which is disposed at another end of the ejection channel 110e opposite to the end thereof connected to the discharge opening 110o, and the partition portion 112 has a through hole (please refer to FIG. 2, not marked), and the push rod 122 is through the through hole, and the elastic member 124 abuts the partition portion 112.

In some embodiments, the push rod 122 includes a rod body 1222 and a top member 1224. The top member 1224 covers a top portion of the rod body 1222. In some embodiments, the top member 1224 is an elastomer, such as made of rubber, but the invention is not limited thereto. In some embodiments, the elastic member 124 abuts between the partition portion 112 and the top member 1224. In some embodiments, the push rod 122 further includes a fixing member 1226 configured to fix the top member 1224 on the top portion of the rod body 1222. In some embodiments, the fixing member 1226 is a screw, but the invention is not limited thereto.

In some embodiments, the ejection device further includes a driving assembly 130, which includes a gear 132 and a driving member 134.

The gear 132 has a main body 1322 and two teeth 1324. The two teeth 1324 are disposed on an outer circumferential surface of the main body 1322 and separated from each other. In some embodiments, the two teeth 1324 are opposite to each other to define two toothless regions opposite to each other.

The driving member 134 is configured to drive the gear 132 to rotate. In some embodiments, the driving member 134 is a portion of a motor (not shown). In some embodiments, the push rod 122 further has a convex portion 122p adjacent to the gear 132. In some embodiments, the convex portion 122p extends toward the gear 132.

The ejection process of the ejection device is described below. First, as shown in FIGS. 2 to 4, when the driving member 134 drives the gear 132 to rotate, one of the two teeth 1324 interferes with the convex portion 122p to drive the push rod 122 to move in a direction away from the discharge opening 110o to compress the elastic member 124, at this time, the food 201 smoothly falls into the ejection channel 110e and enters the recess 110r. Next, as shown in FIGS. 4 to 6, when the driving member 134 continues to drive the gear 132 to rotate, the one of the two teeth 1324 leaves the convex portion 122p to release the elastic member 124 and drive the push rod 1222 to eject, so the food 201 located in the recess 110r is ejected and leaves the discharge opening 110o.

In some embodiments, the main body 1322 of the gear 132 has a convex shaft 13222 extending outward from a peripheral region of an outer surface of the main body 1322. In some embodiments, the ejection device further includes a stirring member 140. One end of the stirring member 140 is pivotally connected to the convex shaft 13222, and another end of the stirring member 140 is close to or located in the feed channel 110f. When the driving member 134 drives the gear 132 to rotate, the convex shaft 13222 drives the stirring member 140 to move to avoid the food getting stuck between the container 110c and the feed channel 110f. It can be seen from this that the ejection device of the present invention can provide both the ejection function (using the ejection member 120) and the stirring function (using the stirring member 140) through the same driving member 134.

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not intended to limit the scope of claims of the present invention.

What is claimed is:

1. An ejection device, comprising:
a housing, defining a feed channel, an ejection channel and a discharge opening, wherein one end of the feed channel is connected to a portion of the ejection channel, and the portion of the ejection channel has a recess facing the end of the feed channel, and one end of the ejection channel away from the feed channel is connected to the discharge opening; and
an ejection member, partially disposed in the ejection channel, the ejection member comprising:
a push rod, having a top portion facing the discharge opening, wherein a width of the top portion of the push rod is smaller than a width of the ejection channel; and
an elastic member, adjacent to the top portion of the push rod and surrounding a portion of the push rod that is disposed in the ejection channel, wherein when the elastic member is not compressed, at least a portion of the top portion of the push rod is between the end of the feed channel and the recess.

2. The ejection device of claim 1, wherein the housing has a partition portion disposed at another end of the ejection channel opposite to the end thereof, and the partition portion has a through hole, and the push rod is through the through hole, and the elastic member abuts the partition portion.

3. The ejection device of claim 1, wherein the recess is located within a vertical projection of the feed channel, and the recess is offset toward the discharge opening relative to the vertical projection of the feed channel.

4. The ejection device of claim 1, wherein the top portion of the push rod is cone-shaped or truncated-conical.

5. The ejection device of claim 1, wherein the push rod comprises:
a rod body; and
a top member, covering a top portion of the rod body.

6. The ejection device of claim 1, wherein the elastic member is a conical spring.

7. The ejection device of claim 1, further comprising:
a driving assembly, comprising:
a gear, having a main body and two teeth disposed on an outer circumferential surface of the main body and separated from each other; and
a driving member, configured to drive the gear to rotate, wherein the push rod further has a convex portion adjacent to the gear, and when the driving member drives the gear to rotate, one of the two teeth interferes with the convex portion to drive the push rod to move in a direction away from the discharge opening to compress the elastic member.

8. The ejection device of claim 7, wherein when the driving member continues to drive the gear to rotate, the one of the two teeth leaves the convex portion to release the elastic member and drive the push rod to eject.

9. The ejection device of claim 8, wherein the main body of the gear has a convex shaft extending outward from a peripheral region of an outer surface of the main body.

10. The ejection device of claim 9, further comprising:
a stirring member, wherein one end of the stirring member is pivotally connected to the convex shaft, and another end of the stirring member is close to or located in the feed channel, wherein when the driving member drives the gear to rotate, the convex shaft drives the stirring member to move.
